(19) United States
(12) Patent Application Publication
(10) Pub. No.: US 2005/0125896 A1
(43) Pub. Date: Jun. 16, 2005

(54) Motorized operating table

(75) Inventors: Patrice Cavalier, Saint Ay (FR); Philippe Daury, Boulogne (FR); Pierre Mercier, Neuvy en Sullias (FR); Bertrand Plouviez, Saint Jean de Braye (FR); Jean-Marie Poussot, Saint Jean le Blanc (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: FHSURGICAL, an organization of France, Paris (FR)

(21) Appl. No.: 10/987,235

(22) Filed: Nov. 12, 2004

(30) Foreign Application Priority Data
Nov. 14, 2003 (FR) FR 03/13377

(51) Int. Cl. A61G 13/00; A61G 13/10

(52) U.S. Cl. 5/600

(57) ABSTRACT

The present invention pertains to a motorized operating table (1) of the type comprising a horizontal platform (2) for supporting a patient, equipped at least in part with a side rail (3) for accessories, said platform (2) being affixed on a chassis mounted on wheels, characterized in that said table (1) comprises a control unit (7) for controlling the displacement of the operating table (1) attached on the side rail (3) and coupled to a base comprising a motor unit (8), said control unit (7) comprising control means for actuating the operating or the stopping of said motor unit.

The present invention pertains to a motorized operating table of the type comprising a horizontal platform for supporting a patient equipped at least in part with a side rail for accessories, said platform being affixed to a chassis mounted on wheels.

The operating table of the present invention is intended notably but not exclusively for surgical interventions.

During surgical operations, the patients are transferred from one site to another, more particularly from their room to the operating room where they will undergo the surgical intervention. Transfer of the patients is performed conventionally by means of transport gurneys which are displaced manually by the medical personnel. The patients are transferred from their bed to the transport gurney to be brought to the operating room where they are transferred from the transport gurney to the operating table. Such patient transfers are not easy to handle and represents risks of injuries for the medical personnel. Similarly, depending on the patient's status, such a transfer can also cause or aggravate the patient's injuries.

There was described in European patent application EP 0917868 an operating table platform connected in a detachable manner to a chassis on wheels. The platform can advantageously be transferred successively from the mobile gurney to a column with fixed support, and vice versa. Although the transfer of the patient to the operating table is no longer performed by direct handling of the patient, the described system nevertheless requires multiple personnel for moving the platform from one support to another. Such a system moreover presents the drawback of being relatively difficult to operate.

Also known in the prior art are gurneys comprising a motorized base. Nevertheless, the systems that allow control of the motor are manual control systems. The handling of such gurneys remains relatively laborious for the medical personnel because they must guide the gurney with one hand and use the other hand for holding the control system.

From international patent application WO 01/51910 there is known a radiotherapy treatment table configured so as to support and position a patient during treatment and mounted on a chassis comprising means forming columns which are mounted on a mobile chassis on wheels. The table comprises a positioning and direction device enabling detection of the position of said table in relation to a radiotherapy station and directing of said table so that it comes into a desired position at the level of said station, in response to the measurement of the actual position. Such a table nevertheless presents limits in that its displacement is directly dependent on the treatment equipment. In order to be displaced, the treatment table must necessarily be positioned close to the radiotherapy station.

The intention of the present invention is to resolve these drawbacks of the prior art.

In order to achieve this goal, the present invention is of the type described above and it is remarkable, in its broadest sense, in that said table comprises a control unit for controlling the displacement of the operating table, which unit is attached on the side rail and coupled to a base comprising a motor unit attached to said operating table, said control unit comprising control means for actuating the operating or shut-off of said motor unit.

The control unit is preferably attached on the side rail in a detachable manner.

Said control unit advantageously constitutes guide arms of said operating table.

The coupling of the control unit and the motor unit is advantageously implemented electrically or optically.

In a preferred mode of implementation of the invention, the coupling of the control unit and the motor unit is implemented via infrared means, said motor unit comprising an infrared sensor. In such a configuration, the infrared emitted by said control unit are advantageously directive so as to present an emission zone limited to a surface surrounding the infrared sensor of the motor unit, said surface being inscribed in the upper surface of said base.

The control means advantageously transmit to the motor unit coded displacement orders that are not specific to the operating table. Thus, when the control unit is configured to be attached in a detachable manner on the side rail formed around the platform of the operating table, said control unit could be adjusted and operated with any other operating table equipped with a base comprising a motor unit with which said control unit could be coupled.

According to one advantageous mode of implementation of the invention, said table furthermore comprises a detector of attachment of said control unit on said operating table. Said attachment detector has the function of deactivating the motor unit in the absence of attachment of said control unit on said operating table.

Said motor unit is advantageously attached on the support of said operating table, preferably centrally in relation to said support.

Said motor unit advantageously controls at least one of the wheels of said operating table and preferably a wheel positioned centrally in relation to said support.

The present invention also pertains to an accessory for motorized operating table of the type comprising a horizontal platform for supporting a patient equipped at least in part with a side tail for accessories, said platform being affixed on a chassis mounted on wheels, said accessory consisting of guide arms of said operating table attached in a detachable manner on the side rail of said support. Said guide arms comprise a control unit controlling the displacement of said operating table coupled to a base comprising a motor unit as well as control means for actuating the operating or shut-down of said motor unit.

The coupling of the control unit and the motor unit is implemented optically, preferably via infrared means. The infrared emitted by said control unit and received by an infrared sensor of said motor unit are directive and advantageously present a conical emission zone the intersection of which with the top surface of the base forms a detection surface comprising the infrared sensor of the motor unit.

The control means advantageously transmit to the motor unit coded displacement commands not specific to said operating table. Thus, as indicated above, it is thus possible to use the control unit on any operating table as long as it is equipped with the necessary equipment, i.e., a motor unit enabling coupling with the control unit, said coupling being able to be implemented electrically or optically. Optical coupling is nevertheless preferred so as to facilitate the handling of said control unit.

The present invention also pertains to an operating system comprising a multiplicity of operating tables as previously described, at least one of the operating tables being equipped with an accessory such as described above. The system is configured in such as manner that it advantageously comprises a number of guide arms smaller than or equal to the number of operating tables.

Better understanding of the invention will be obtained from the description below presented for purely explanatory purposes of one mode of implementation of the invention with reference to the attached figures:

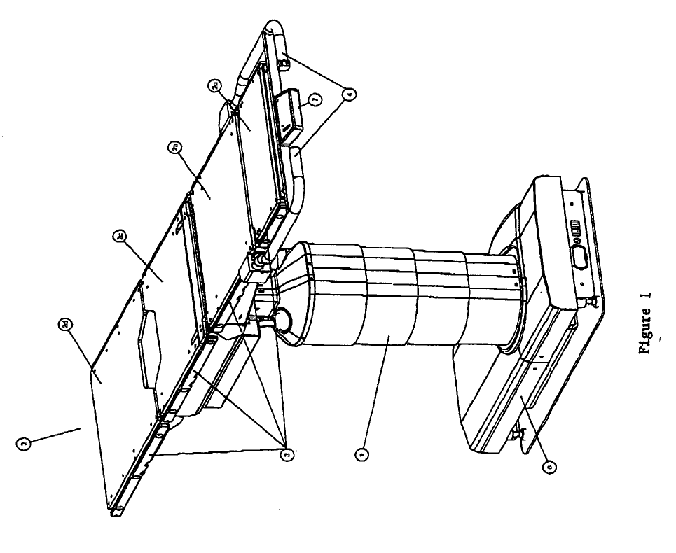

FIG. 1 illustrates a perspective view of an operating table according to the invention; and

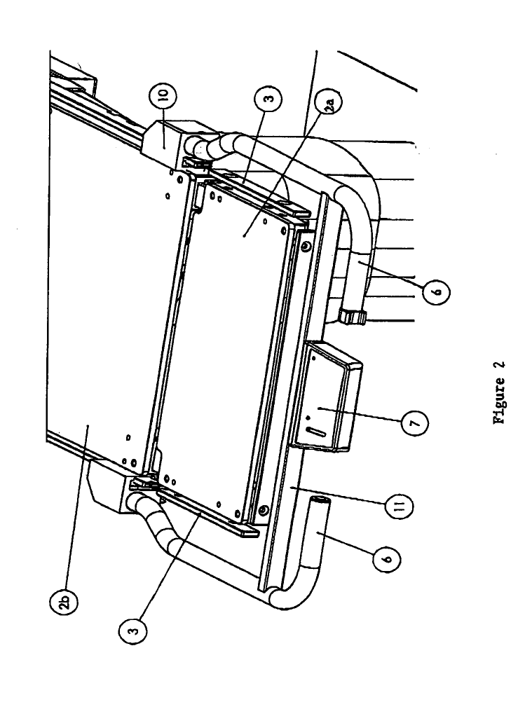

FIG. 2 illustrates an enlarged perspective view of the guide arms according to the invention.

FIG. 1 illustrates an operating table (1) according to the invention intended notably for surgical interventions.

Said operating table (1) is of the type comprising a horizontal platform (2) intended to support a patient, which is affixed to a chassis (9) mounted on wheels.

Said platform (2) is formed advantageously of four parts (2a to 2d) intended to receive respectively the patient's head, back, pelvis and legs. Moreover, said parts (2a to 2d) are connected to each other in a manner so as to allow the respective adjustment of the slope of each of said parts (2a to 2d).

Each part (2a to 2d) of said platform (2) is equipped with side rails (3). The parts (2a to 2d) advantageously constituting respectively the front and the back of said platform (2) are also equipped respectively on their front and rear surface with a side rail. Said rails positioned in this manner on the side of said platform (2) makes it possible to attach the accessories required by the surgeon during a surgical intervention. Said rails are in particular intended for the attachment of surgical tools.

Said operating table (1) moreover comprises guide arms (6) which are attached respectively to the side rails of the part (2b) of said platform (2).

Said guide arms (6) constitute a control unit (7) for controlling the displacement of the operating table (1). In order to achieve this, said control unit (7) is coupled to a base comprising a motor unit (8), said base constituting a part of said operating table (1). More particularly, said base, positioned under the platform (2), constitutes a part of the chassis supporting said platform (2).

It should be noted that the term displacement control should be understood to mean the start-up of the motor, the turn-off of the motor and the control of the displacement speed of said operating table (1).

Similarly, the term displacement of the operating table (1) should be understood to mean the moving forward and moving backward of said operating table so as to move from one position to another. Thus, when the motor unit (8) is activated by means of the control unit (7), the operating table (1), according to the control operated via said control unit (7), will move forward or backward automatically. The turning off of the motor unit will lead to the stopping of the automatic displacement of said operating table (1). It is obviously understood that the turning off of said motor unit (8) will not prevent an intentional manual displacement of said operating table (1).

The coupling of said control unit (7) with said motor unit (8) is implemented electrically or optically.

More precisely, the control unit (7) is coupled with a receiver intended to receive the electrical or optical signals emitted by said control unit (7), said receiver being itself linked to an active computer controlling said motor unit (8).

In one preferred mode of implementation of the invention, the coupling is implemented optically, advantageously by infrared means. For this purpose, the motor unit (8) comprises an infrared sensor (not shown).

In order to prevent any interaction with the operating tables that are also equipped with a motor unit equipped with an infrared sensor, said tables being located in the reception field of the infrared emitted by said control unit (7), the emission of the infrared is directive. More precisely, the emission zone is limited to a surface surrounding the infrared sensor of the motor unit (8), said surface being inscribed in the top surface of said base. Still more precisely, the emission zone is a conical zone the intersection of which with the top surface of the base forms the detection surface containing the infrared sensor.

FIG. 2 illustrates an enlarged view of the control unit of the guide arms (6) attached to the operating table (1) of FIG. 1.

The guide arms (6) are equipped respectively at one of their ends with an attachment element (10) intended to be attached on the rails as accessories surrounding said platform (2). The attachment elements (10) are advantageously affixed on the side rails (4) of the part (2b) of said platform (2).

In this example of implementation, said attachment element (10) presents a cavity configured to allow the attachment element to be clipped on said side rail (3).

Said guide arms (6) present at their free ends a zone forming a handle. One of the handles is advantageously equipped at its end with a security button that can pivot along an axis identical to the longitudinal axis of the zone forming the handle. Said security button enables activation of the displacement of the operating table (1) (move forward or move backward) and the controlling of its speed. In order to facilitate its handling, said security button presents a shape essentially in the form of a thumb.

Said guide arms are connected to each other by a cross bar (11) which supports the control unit (7) intended to control the displacement of said operating table (1).

Said operating table advantageously comprises an attachment detector (not shown) of said control unit (7). Thus, in the absence of attachment of said control unit (7) on the side rails (3) of said platform (2), said attachment detector will deactivate the motor unit (9).

One of the principal advantages of the present invention is to provide guide arms (6) that can be adapted to any operating table (1) equipped with a motor that can coupled electrically or optically with said guide arms (6). It would therefore be advantageous if the commands emitted by the control unit (7) to said motor unit (8) consisted of coded displacement commands the coding of which would not be specific to an operating table (1). Thus, in the case of a system comprising multiple operating tables (1), it would not be necessary to necessarily provide as many guide arms (6) as there are operating tables (1).

The invention was described above as an example. It is understood that the expert in the field could implement different variants in the invention without thereby going beyond the framework of the patent.

1. Motorized operating table (1) of the type comprising a horizontal platform (2) for supporting a patient, equipped at least in part with a side rail (3) for accessories, said platform (2) being affixed on a chassis mounted on wheels, characterized in that said table (1) comprises a control unit (7) for controlling the displacement of the operating table (1) attached on the side rail (3) and coupled to a base comprising a motor unit (8) attached to said operating table, said control unit (1) comprising control means for actuating the operating or the stopping of said motor unit.

2. Operating table (1) according to claim 1, characterized in that the control unit (7) is attached to the side rail in a detachable manner.

3. Operating table (1) according to claim 1 or claim 2, characterized in that said control unit (7) constitutes guide arms (6) of said operating table.

4. Operating table (1) according to any one of the preceding claims, characterized in that the coupling of the control unit (7) and the motor unit (8) is implemented electrically or optically.

5. Operating table (1) according to the preceding claim, characterized in that the coupling of the control unit (7) and the motor unit (8) is implemented by infrared means, said motor unit (8) comprising an infrared sensor.

6. Operating table (1) according to the preceding claim, characterized in that the infrared emitted by said control unit (7) are directive and present an emission zone limited to a surface surrounding the infrared sensor of the motor unit (8), said surface being inscribed in the top surface of said base.

7. Operating table (1) according to any one of the preceding claims, characterized in that the command emitted by said control unit (7) to said motor unit (8) consists of coded displacement commands not specific to said operating table (1).

8. Operating table (1) according to any one of the preceding claims, characterized in that said table (1) furthermore comprises a detector of attachment of said control unit (7) on said operating table (1), said attachment detector deactivating the motor unit (8) in the absence of attachment of said control unit (7) on said operating table (1).

9. Operating table (1) according to any one of the preceding claims, characterized in that said motor unit (8) is positioned under the platform (2) of said operating table (1) and preferably centrally in relation to said platform (2).

10. Operating table (1) according to any one of the preceding claims, characterized in that said motor unit (8) is linked to at least one of the wheels of said operating table (1), and preferably to a wheel positioned centrally in relation to said platform (2).

11. Accessory for motorized operating table (1) of the type comprising a horizontal platform (2) for supporting a patient equipped at least in part with a side rail (3) for accessories, said platform (2) being affixed on a chassis mounted on wheels, characterized in that said accessory consists of guide arms (6) of said operating table (1) attached in a detachable manner on the side rail (3) of said platform (2), said guide arms (6) comprising a control unit (7) for controlling the displacement of said operating table (1) coupled to a base comprising a motor unit (8) and comprising control means for actuating the operating or the stopping of said motor unit (8).

12. Accessory according to the preceding claims, characterized in that the coupling of the control unit (7) and the motor unit (8) is implemented optically, preferably by infrared means, the infrared emitted by said control unit (7) and received by an infrared sensor of said motor unit (8) being directive and presenting preferably a conical emission zone the intersection of which with the top surface of the base forms a detection surface comprising the infrared sensor of the motor unit (8).

13. Accessory according to claim 10 or claim 12, characterized in that the command emitted by said control unit (7) to said motor unit (8) consists of coded displacement commands which are not specific to said operating table (1).

14. Operating system comprising a multiplicity of operating tables (1) according to any one of claims 1 to 10 equipped with an accessory according to any one of claims 11 to 13, characterized in that the number of guide arms (6) is lower than or equal to the number of operating tables (1).
